(19) United States
(12) Patent Application Publication
(10) Pub. No.: US 2025/0070556 A1
(43) Pub. Date: Feb. 27, 2025

(54) PROVIDING SECONDARY FREQUENCY REGULATION SUPPORT TO A POWER TRANSMISSION SYSTEM USING BEHIND-THE-METER ENERGY RESOURCES AND SUBSTATION BATTERY

(71) Applicant: Board of Regents of the Nevada System of Higher Education, on behalf of the University of Nevada,, Reno, NV (US)

(72) Inventors: Mohammed Ben-Idris, Okemos, MI (US); Jitendra Thapa, East Lansing, MI (US)

(21) Appl. No.: 18/797,661

(22) Filed: Aug. 8, 2024

Related U.S. Application Data
(60) Provisional application No. 63/578,420, filed on Aug. 24, 2023.

(51) Int. Cl. H02J 3/24; H02J 3/32; H02J 3/38; H02J 7/00; H02J 13/00

(52) U.S. Cl. CPC H02J 3/241; H02J 3/32; H02J 3/381; H02J 7/0048; H02J 7/00712; H02J 13/00002; H02J 13/00007; H02J 2203/10; H02J 2203/20

(57) ABSTRACT

Methods, apparatus and systems for providing secondary frequency regulation support to a power transmission system. In some embodiments, a real-time central controller requests current status data from a power distribution network which includes a plurality of distributed energy resources (DERs) and at least one substation battery energy storage system (BESS). The real-time central controller also receives an Automatic Generation Control (AGC) signal from a system operator, calculates a mismatch value, determines that the absolute value of the mismatch value is greater than a predetermined tolerance, and sets an optimal setpoint value for each of the plurality of DERs and an optimal setpoint value for the BESS. In some implementations, the real-time central controller next transmits a secondary frequency response that includes the optimal setpoint values to each of the plurality of DERs and the optimal setpoint value to the at least one BESS, thus providing secondary frequency regulation support.

### CROSS REFERENCE TO RELATED APPLICATION

This U.S. Patent Application claims priority to co-pending U.S. Provisional Patent Application No. 63/578,420 filed on Aug. 24, 2023 entitled PROVIDING SECONDARY FREQUENCY REGULATION SUPPORT TO A POWER TRANSMISSION SYSTEM USING BEHIND-THE-METER ENERGY RESOURCES AND SUBSTATION BATTERY, the contents of which application are hereby incorporated by reference for all purposes.

### ACKNOWLEDGMENT OF GOVERNMENT SUPPORT

This invention was made with U.S. government support under Grant No. DE-EE0009022 awarded by the United States Department of Energy. The U.S. government has certain rights in the invention.

### BACKGROUND

Distributed energy resources (DERs) are small-scale electricity supply or demand resources that are interconnected to a power transmission system and/or to an electric grid. DERs are power generation resources that are typically located close to load centers and can be used individually or in aggregate to provide power back into the power transmission system and thus provide value.

DERs include a variety of physical and virtual assets. Physical DERs are typically under 10 MW (Megawatts) in capacity, and can consist of diesel or natural gas generators, solar arrays, small wind farms, microturbines, battery energy storage systems (BESSs), and the like. In some cases, DERs are owned and operated by an electric utility company, while in others they are owned and operated by independent power producers such as local businesses, and/or by consumers. In some implementations, an electric utility company directs their operation to obtain power in the same way that it controls the operation of large central power plants, requesting starts and stops as needed.

DERs may be aggregated together and their resources made available to the electric utility or to the electric grid. From the electric utility's perspective, an aggregation of DERs appears as a single resource, like a power plant. For example, an aggregation of DERs that includes one-hundred solar arrays of 10 KW is the same as a single solar farm having 1000 kW of solar capacity to the electric utility.

An aggregation of DERs can be made up of a single type of DER or asset or a mix of various asset types. For example, behind-the-meter (BTM) diesel generators, solar panel systems (which include batteries), electric vehicles and the like can be aggregated to form an aggregation of DERs. Thus, any particular aggregation of DERs possesses its own specific operational profile.

The U.S. Federal Energy Regulatory Commission (FERC) defines a distributed energy resource (DER) as referring to “any resource located on the distribution system, any subsystem thereof or behind a customer meter” and has recognized that such technologies may provide individual benefits to the end-use customers who own them. Thus, FERC Order No. 2222 was released which opens a path for new and potentially increased value based on intelligently combining or aggregating many DERs into a single virtual resource that can reduce costs for a bulk power system. An aggregation of DERs submitted as a single offer may participate in the capacity, energy, and ancillary service markets operated by regional transmission organizations (RTOs) and independent system operators (ISOs). In these markets, the types of DER technologies that make up an aggregation are not as important as the total number of megawatts (up or down) that the aggregation can provide dependably when requested to do so by the RTO. The expectation is that the combined value to the electric grid of an aggregation of DERs is greater than the apportioned value individual DER owners would get by marketing or controlling their resources separately, which additional value could be shared among the individuals participating in the DER aggregation.

Many conditions can lead to frequency regulation problems for power systems, and high penetration of renewable energy resources is one of them. Thus, as a result of the adoption of aggressive and ambitious targets for using renewable energy resources for grid decarbonization by many countries, frequency regulation problems for the power systems in those countries have occurred. Recognizing that future power systems may be dominated by DERs, FERC Order 2222 was promulgated which includes standards that enable several grid services, such as frequency regulation (sometimes also referred to as secondary frequency response), for power systems that utilize behind-the-meter (BTM) DERs. Accordingly, dispatchable resources such as energy storage systems (ESSs), and distributed generators (DGs) such as diesel generators, microturbines, and fuel cells combined with utility scale substation batteries have huge potential for secondary frequency regulation (SFR). As these BTM resources are connected at medium and low voltage levels, a comprehensive framework may be provided that enables an active distribution network integrated with DERs for SFR support, which may be an indispensable resource for future electric grids.

Researchers have investigated power system frequency regulation in the context of exploiting the flexibility and quick ramping support of DERs in response to a frequency deviation. Although the results of such research have shown that DERs can be used for SFR, the studies were conducted at the level of transmission and/or at the microgrid level. Not much attention has been paid to the participation of an active distribution system that includes small-scale BTM resources for real-time SFR.

Thus, the inventors recognized that there is a need for systems, apparatus and processes that would provide real-time coordinated control of substation battery energy storage systems (BESSs) and DERs for the purpose of providing secondary frequency regulation (SFR) support to a power transmission system.

### SUMMARY OF THE INVENTION

Presented are methods, apparatus and systems for providing secondary frequency regulation support to a power transmission system. In some embodiments, a real-time central controller requests current status data from a power distribution network that includes a plurality of behind the meter (BTM) distributed energy resources (DERs) and at least one substation battery energy storage system (BESS). The real-time central controller receives current status data from the power distribution network, and receives an Automatic Generation Control (AGC) signal from a system operator. The real-time central controller then calculates a mismatch value based on the current status data and the AGC signal, determines that the absolute value of the mismatch value is greater than a predetermined tolerance, and sets, in response to the determination, an optimal setpoint value for each of the plurality of DERs and an optimal setpoint value for the at least one BESS.

In some embodiments, the real-time central controller transmits, via a distribution substation, a secondary frequency response including the optimal setpoint values to each of the plurality of DERs and the optimal setpoint value to the at least one BESS for secondary frequency regulation support, wherein a time frame for the secondary frequency response may be a range from several seconds to several minutes. Some implementations include the real-time central controller, prior to requesting the current status data, initializing a time interval for requesting the receipt of current status data from the power distribution network. In some embodiments, the plurality of DERs comprises fast-responding DERs.

The current status data, in some implementations, includes a setpoint value for each of the plurality of distributed energy resources (DERs), a state-of-charge (SOC) value and a setpoint value of the substation battery energy storage system (BESS), and a power value representative of power supplied by the power transmission system. In addition, in some cases setting an optimal setpoint value for each of the plurality of DERs and an optimal setpoint value for the at least one BESS includes the central controller receiving input values including a current setpoint value for each of the plurality of DERs, the mismatch value, a total distributed generator (DG) value, a total power loss value, and a total demand value, and then generating, by using a linearized optimal power flow process, optimal setpoint values for each of the plurality of DERs and the optimal setpoint value for the at least one BESS. In addition, in some implementations the real-time central controller receives the status data from the power distribution network at time intervals of four (4) seconds.

Another embodiment is directed to a central controller for providing secondary frequency regulation support to a power transmission system. The central controller includes a processor and a memory operably connected to the processor. The memory stores processor-executable instructions which when executed cause the processor to request current status data of a power distribution network, wherein the power distribution network comprises a plurality of behind the meter (BTM) distributed energy resources (DERs) and at least one substation battery energy storage system (BESS), receive the current status data from the power distribution network, and receive an Automatic Generation Control (AGC) signal from a system operator. The memory also stores processor-executable instructions which when executed cause the processor to calculate a mismatch value based on the current status data and the AGC signal, determine that the absolute value of the mismatch value is greater than a predetermined tolerance, and set, in response to the determination, an optimal setpoint value for each of the plurality of DERs and an optimal setpoint value for the at least one BESS.

In some implementations, the memory may also include processor-executable instructions which when executed cause the processor to transmit the optimal setpoint values to each of the plurality of DERs and the optimal setpoint value to the BESS for secondary frequency regulation support, and in some cases the time frame for the secondary frequency response is a range from several seconds to several minutes. In some embodiments, the memory also includes processor-executable instructions which when executed cause the processor to, prior to requesting the current status data, initialize a time interval for use in requesting the receipt of current status data from the power distribution network. In some cases the plurality of DERs comprise fast-responding DERs.

In some embodiments of the central controller, the current status data includes a setpoint value for each of the plurality of DERs, a state-of-charge (SOC) value and a setpoint value of the substation battery energy storage system (BESS), and a power value representative of power supplied by the power transmission system. In addition, in some implementations, the instructions for setting an optimal setpoint value for each of the plurality of DERs and an optimal setpoint value for the BESS includes processor-executable instructions which when executed cause the processor to receive input values including a current setpoint value for each of the plurality of DERs, the mismatch value, a total distributed generator (DG) value, a total power loss value, and a total demand value, and generate, using a linearized optimal power flow process, optimal setpoint values for each of the plurality of DERs and the optimal setpoint value for the BESS. Also, in some cases the time interval for receiving status data from the power distribution network is four (4) seconds.

Yet another embodiment pertains to a high-level communication framework for simulating the dispatching of optimized set-points of distributed energy resources (DERs) for secondary frequency regulation of an electrical grid. The communication framework includes a gateway computer, a local machine computer operably connected to the gateway computer, and distribution grid assets operably connected to the gateway computer. In implementations, the gateway computer includes a memory storing instructions which when executed cause the gateway computer to receive data from the distribution grid assets concerning a plurality of distributed energy resources (DERs) and concerning at least one battery energy storage system (BESS), transmit the data from the distribution grid assets to the local machine computer, receive data from the local machine computer comprising updated set-points for each of the plurality of DERs and for the at least one BESS, and transmit the optimal set-points for each of the plurality of DERs to the distribution grid assets for dispatch to each respective DER.

In some embodiments of the high-level communication framework, the local machine computer receives a state of charge (SOC) value and a power supplied value from the electrical grid at intervals of every four (4) seconds.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate example embodiments which are not necessarily drawn to scale, wherein:

FIG. 1 is a graph of power system frequency over time to illustrate the three different levels of frequency response in accordance with some embodiments of the disclosure;

FIG. 2 is a graph illustrating the tracking of Automatic Generation Control (AGC) signals by regulating units in response to the supply and demand imbalance in accordance with some embodiments of the disclosure;

FIG. 3 is a system block diagram of a high-level architecture for describing how a real-time secondary frequency response (SFR) is accomplished in accordance with some embodiments of the disclosure;

FIG. 4 depicts a high-level communication framework for dispatching optimized set-points of DERs for secondary frequency regulation utilizing assets of a distribution grid in accordance with some embodiments of the disclosure;

FIG. 5 is a workflow diagram for determining and dispatching optimal setpoints for DERs for secondary frequency response (SFR) purposes in accordance with some embodiments of the disclosure;

FIG. 6 illustrates a portion of an active radial distribution network for the illustration of the Dist-Flow power flow model; and

FIG. 7 is a graph illustrating the application of piecewise linearization of quadratic active components of Pⱼ^{loss}.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of the embodiments may be practiced without some or all of the specific details. In other instances, well-known process operations have not been described in detail in order not to unnecessarily obscure novel aspects. In addition, terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used.

In general, and for the purposes of introducing concepts of embodiments of the present invention, disclosed herein are methods, apparatus and systems for utilizing behind-the-meter (BTM) energy sources (for example, home solar panel systems and/or other types of electric storage systems) to provide secondary frequency support to a power transmission system or an electric power grid. In particular, inverter-based BTM distributed energy resources (DERs) and battery energy storage systems (BESS) have fast response characteristics that can be used for secondary frequency support. Specifically, a number of small-scale DERs managed by transmission system aggregators can provide power at scale to track an Automatic Generation Control (AGC) signal from an electric utility and thus mitigate any frequency deviation(s) that may occur. The AGC is a major control function within the electric utility's energy control center, whose purpose is to track load variations while maintaining system frequency, net tie-line interchanges, and optimal generation levels that are close to scheduled (or specified) values.

It has been recognized that in some circumstances conventional AGC resources cannot fully restore the frequency to nominal value. Thus, the disclosed systems, methods and apparatus include fast responding DERs and a BESS that can be used to act quickly to recover the frequency. In some embodiments, a disclosed real-time secondary frequency regulation framework is integrated with a linearized optimization process for determining the control set-points of BTM battery energy storage systems (BESS) resources in response to the AGC signal. A linearized power flow model which is computationally efficient and suitably fast for use in providing secondary frequency control may be utilized.

One of the major operations in a power system is to maintain the balance between power generation and the load such that the system frequency is maintained at a nominal value. But frequency events can occur for various reasons such as the loss of a large generator, and/or large-scale load shedding, and/or the failure of tie-lines. The frequency control during an event involves three levels of control: inertial with a primary control, Automatic Generation Control (AGC) or secondary control, and a tertiary control.

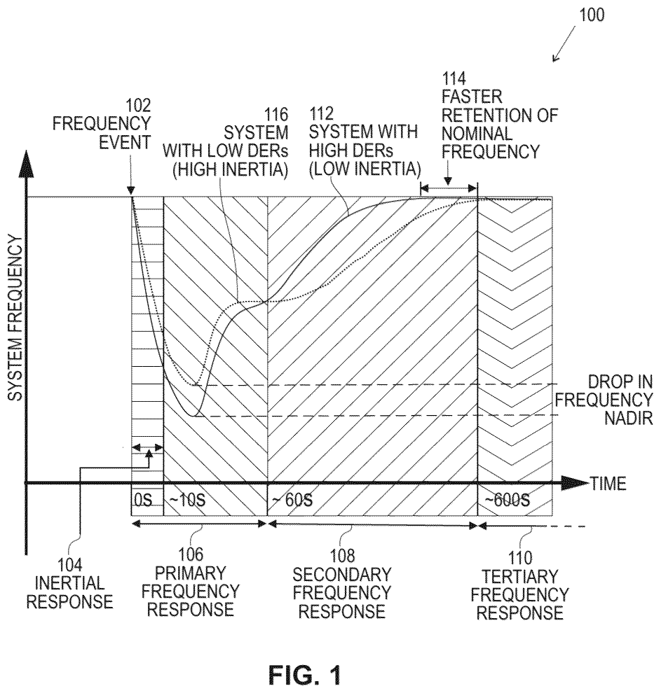

FIG. 1 is a graph 100 of power system frequency over time to illustrate the three different levels of frequency control and response. In particular, after a frequency event 102 occurs, there is an inertial response 104 followed by a primary frequency response (PFR) 106, a secondary frequency response 108 and a tertiary frequency response 110 that occurs over time. The inertial response 104 involves the automatic release of kinetic energy stored in a rotating mass of synchronous generators. Given a mismatch between generation and consumption, stored energy from all the connected resources is injected into the system in a time frame of seconds. The rate of decrease in system frequency and the depth of the frequency nadir shown in FIG. 1 depends upon the inertial response of the system.

After the inertial response 104, the primary frequency control comes into operation, without external input, and results in the system's primary frequency response (PFR) 106. The main objective of the primary frequency control 106 is to stabilize the frequency by means of a governor action and demand response. A governor response involves constant modulation of the machine's mechanical input energy also referred to as “droop” in the field of power generation. The droop of a synchronous generator is represented in terms of the percent of frequency change that controls the regulation of mechanical input in response to frequency excursion. The demand response aspect of a PFR 106 assumes that the frequency-dependent load-like motors change their speed (and consequently consumption) in a proportionate amount of frequency changes. In addition, frequency-sensitive relays responsible for load disconnection in the event of crossing frequency thresholds are included as demand response-based PFR 106.

As shown in FIG. 1, it is important to note that in some circumstances the PFR 106 may not bring the frequency of the system to the nominal value and that instead the frequency remains at quasi-steady-state value. Therefore, secondary control employs a central controller that adjusts the active power outputs of the power generating units. This adjustment aims to retain the power exchanges with neighboring control areas to their intended values while simultaneously restoring the power system frequency to its nominal value. As graphically shown by curve 112 in FIG. 1, fast-responding DERs can be used for SFR 108 resulting in a quick return to the nominal frequency level 114. In contrast, a system that includes slow-response DERs could also be used to provide a more gradual return to the nominal frequency level 114 as shown by the curve 116 in FIG. 1. In some implementations, the time frame of the secondary frequency response (SFR) 108 can range from about several seconds to several minutes. In embodiments disclosed herein, SFR 108 is implemented through the Automatic Generation Control (AGC) which makes informed decisions using Area Control Error (ACE) (which represents the instantaneous imbalance between electric power generation and demand within a specific control area) calculated based on information collected through Supervisory Control and Data Acquisition (SCADA) such as system frequency, regulating unit's set-points, and scheduled and measured power interchange between areas. SCADA systems provide real-time data, visualization and control capabilities which allows operators and engineers to remotely manage and optimize the required operations.

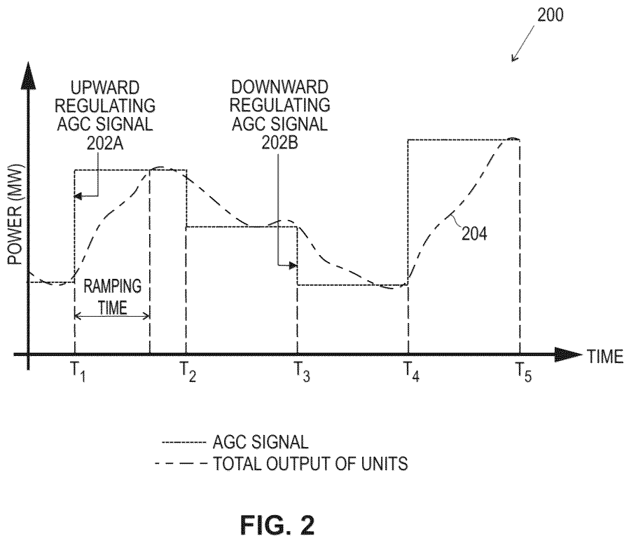

FIG. 2 is a graph 200 illustrating the tracking of Automatic Generation Control (AGC) signals by regulating units in response to the supply and demand imbalance. As shown, upwardly regulating AGC signals 202A and downwardly regulating AGC signals 202B may be utilized, and the curve 204 shows the total output of the units. In particular, the methods disclosed herein employ substation BESS and behind-the meter (BTM) DERs to provide frequency regulation in the timescale of secondary frequency control. As discussed above and as shown in FIG. 1, the curve 112 illustrates the positive impact of fast-responding DERs for SFR. With regulating assets like inverter-based resources and a substation Battery Energy Storage (sBESS), the nominal frequency can be regained quickly in comparison to that of a system without DERs. However, if most of the synchronous generators are replaced by the utility-scale DERs, the inertial response of the system may be poor due to the reduction of system inertia and because the frequency drops occur at a higher rate during an event. Finally, system response to the tertiary frequency control 110 (see FIG. 1), which ensures the retention of resources for primary and secondary responses through proper deployment of reserves considering economic constraints, shows the economic redispatch of available resources after a contingency.

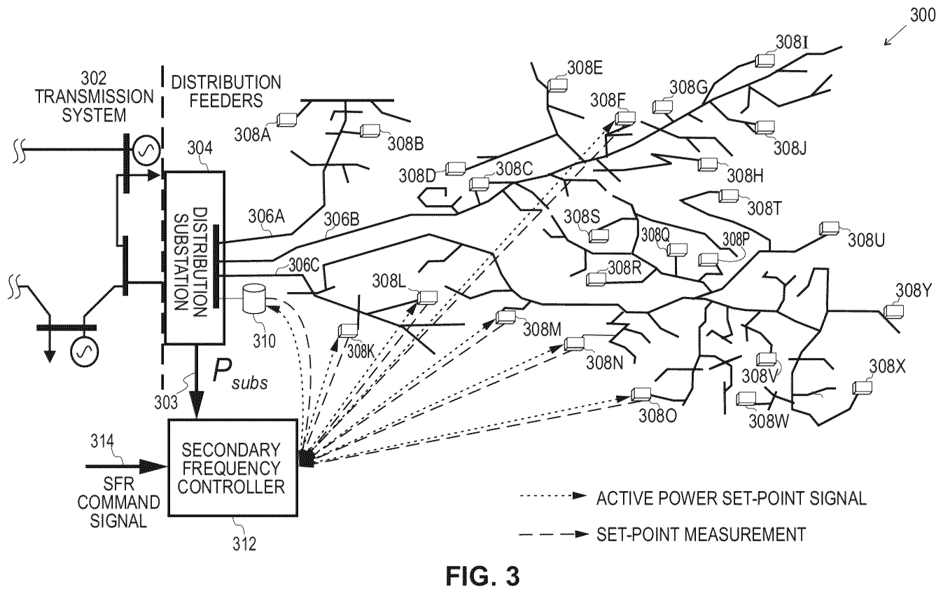

FIG. 3 is a system block diagram of a high-level architecture 300 for describing how a real-time secondary frequency response (SFR) is accomplished in accordance with some embodiments. In particular, secondary frequency control may be accomplished by controlling all or at least some of the fast-responding DERs 308A-308Q shown in FIG. 3, and by controlling a substation battery energy storage (BESS) setpoint of the substation battery 310. As will be explained in more detail hereinbelow, an Automatic Generation Control (AGC) signal received by a real-time controller from a system operator (SO) is taken into consideration along with the current operating set-points of the DERs, the state-of-charge (SOC) of the substation battery (or batteries) along with its set-point so as to optimally distribute and dispatch the respective AGC signal among the regulating assets. Thus, disclosed is a framework for integrating active distribution networks and for optimally mobilizing behind-the-meter (BTM) resources in response to an AGC signal received from the system operator (SO).

Referring again to FIG. 3, the high-level architecture 300 includes a transmission system 302 operably connected to a distribution substation 304 which is operably connected to a plurality of distribution feeders 306A, 306B and 306C. The distribution feeders 306A, 306B and 306C provide electricity to end users or consumers and in this example some of the consumers have and/or operate distributed energy resources 308A-308Y, which are connected to the feeder lines. The distribution substation 304 is also operably connected to a substation battery 310 and to a secondary frequency controller 312. The secondary frequency controller 312 may include one or more computer processors and/or computers and/or server computers. In some implementations, the central controller 312 may include one or more processors operably connected to one or more memory device(s), wherein the memory device(s) store processor-executable instructions which when executed provide the functionality disclosed herein.

In some embodiments, the secondary frequency controller 312 (or central controller) is operable to receive an AGC control signal 314 (or SFR command signal) from the transmission system operator 302 and to receive a P subs signal 303 from the distribution substation 304 while also communicating with a plurality of DERs. Specifically, the central controller or secondary frequency controller 312 is configured to transmit active power set-point signals to, and receive set-point measurement signals from, each of the DERs 308A-308Y and the distribution substation battery 310.

Since the control and visibility that the balancing authority (such as the transmission system 302) has over these regulating assets are limited, the system operator (SO) handles the operation of the central controller or secondary frequency controller 312. Thus, the SO serves as an intermediary between the balancing authorities and the owners of the distribution assets (for example, consumers who own the DERs). SOs have the capability to coordinate distributed generations, manage microgrids, and handle demand response assets. Through contractual agreements with the owners of the small energy generators, SOs can receive services for distribution grids and compensate the owners of the small-scale generators for their contributions.

In implementations disclosed herein, the SOs, which may own and operate the centralized secondary frequency controller 312, perform optimization that determines the optimal active power set-points of regulating units (the DERs and the BESS) while taking the AGC command signals 314 into consideration. Accordingly, before running an optimization, the central controller 312 requires information about the current status of the distribution network and its assets such as operating set-points of substation BESS 310 and each of the participating DERs, which in the example shown in FIG. 3 include DERs 308F, 308K, 308L, 308M, 308N and 3080, the state-of-charge (SOC) level of BESS, the power injected by the grid, and the AGC command signal 314 from the SO. In some implementations, for scalable integration of DERs for grid services the IEEE 1547 standardized list of protocols (which may include DNP3, SunSpec Modbus, and IEEE 2030.5), and a set of functionality items that must be supported by the communication protocols, are followed.

Assuming a communication interface between the participating DERs 308F, 308K, 308L, 308M, 308N and 308O and the central controller 312, a bidirectional communication channel is utilized to receive information from the DERs and optimally dispatch (or transmit) regulating commands to the respective DERs. During operation, optimal dispatch (or transmission) of active power set-points are followed by a mismatch calculation through a comparison of the power at the substation before and after the dispatch. If the change in the substation power is not reflected as per the AGC command 314, a corrective action is then implemented taking the respective mismatch as the reference. Such operation may provide a foundation to develop and integrate multiple distribution systems to provide large enough aggregated power that can then impact the frequency at the transmission level. In addition, such functionality beneficially facilitates the widespread adoption of the distributed energy resources (DERs), which directly enhances the system's flexibility for other grid services. Moreover, the disclosed framework is flexible and thus may employ other grid services such as voltage regulation, phase balancing, and loss reduction.

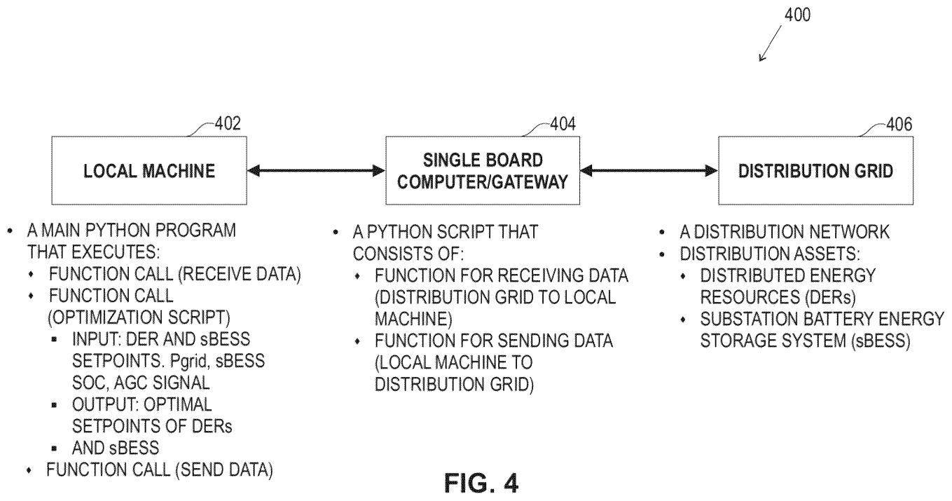

FIG. 4 is an example of a high-level communication framework 400 for dispatching optimized set-points of DERs for secondary frequency regulation utilizing distribution system assets of a distribution grid 406 which may be utilized for simulation and/or validation purposes. In order to provide communications, a single board computer 404 (for example, an inexpensive Raspberry Pi device) may be utilized which may act as a gateway between the local machine 402 (i.e., the centralized controller 312 of FIG. 3) and the distribution grid 406 (including any assets of the distribution grid). In some implementations, the single board computer 404 may run Python scripts or other type of processor executable instructions that include a function for receiving data (from the distribution grid for transmission to the local machine) and a function for sending data (from the local machine to the distribution grid). As explained above, during operation for secondary frequency control, the centralized controller 312 (local machine 402) receives updated set-points for each of the DERs and from the substation battery 310, and in some implementations receives the state of charge (SOC) and the power supplied by the electrical grid at intervals of every five seconds (5 seconds) through gateways. The optimal set-points for each of the DERs are then sent back and dispatched to each respective DER by the centralized controller 312. Such operation may be simulated using the communication framework 400 depicted by FIG. 4.

Referring again to FIG. 4, for validation purposes the local machine 402 may include a main program (of processor executable instructions) that executes a function call to receive data and another function call to perform optimization (via an optimization script) by utilizing the following inputs: DER setpoints and sBESS setpoints, P_{grid} (which is the power injected by the electrical grid to the distribution system), sBESS SOC and the AGC signal. The optimization script then outputs the optimal setpoints for the DERs and for the sBESS. The main program running on the local machine may also execute a function call to send the optimization data (the optimal setpoints for the DERs and the sBESS) to the gateway 404. As discussed above, the gateway 404 may include a computer program which may be called from the local machine 402 to execute to send data (Local Machine 402 to the Distribution Grid 406) and may include processor executable instructions for receiving data (Distribution Grid 406 to the Local Machine 402). With respect to the high-level communication framework 400, the Distribution Grid 406 may include a simulated Distribution Network that may include modules and/or components for simulating the Distribution Assets including the DERs and the sBESS. For example, the Distribution Grid 406 may include a simulated Distribution Network in RTDS that may include a GTNET-SKT module for facilitating SKT protocol-based communication with the RTDS using TCP or UDP sockets, and Calculation Blocks which are arithmetic blocks modeled in RSCAD simulation software to calculate necessary values. In some implementations, the RTDS may be a dedicated hardware component that includes a powerful processor operable to simulate a power system in real-time.

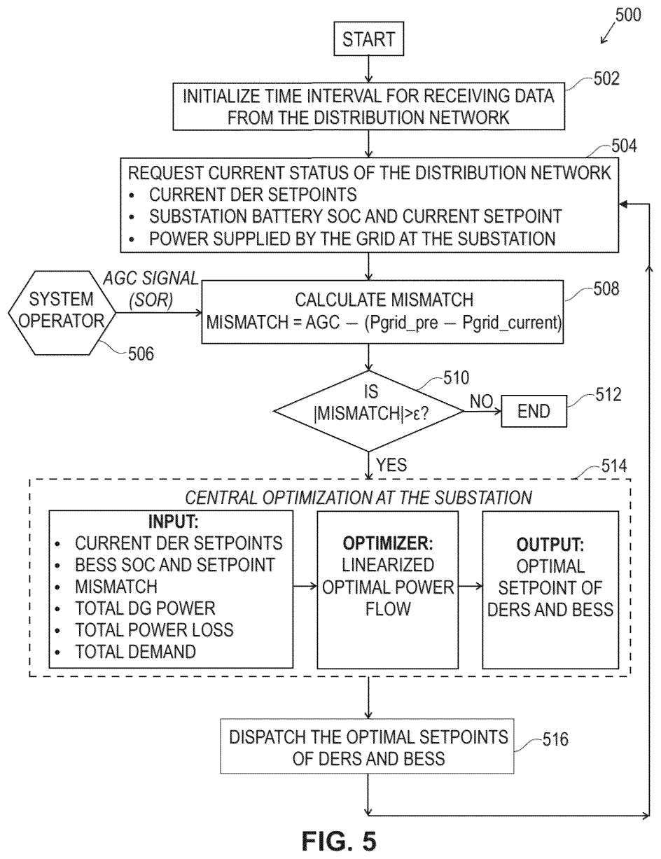

FIG. 5 is a workflow diagram 500 for determining and dispatching optimal setpoints for DERs for secondary frequency response (SFR) purposes in response to an AGC command received from the System Operator (SO) according to some embodiments. Because secondary frequency control involves regulating generating resources quickly, within seconds and to a several minute time-frame, the centralized controller responsible for the SFR should receive the status of the distribution network in a timely manner. Thus, in some implementations the status of the distribution network is received at intervals of every five (5) seconds. In some cases, real world power companies may typically track the response of their assets every 4 to 5 seconds in order to check that power plants, DERs and other system components are responding to commands. In the event that it appears that some assets are not responding to the AGC signal, then system operators may cancel commands for those assets and assign the mismatch to different assets or resources.

As mentioned earlier with regard to FIG. 4, a centralized controller was interfaced with a gateway to simulate activity of a distribution grid. Bidirectional communication between the participating units and the controller is used to receive current operating set-points to determine the available capacity of each regulating unit, and to later dispatch the optimal set-points after an optimization calculation occurs. Thus, a real-time centralized controller (i.e., a Secondary Frequency Controller) receives current set-points of the DERs and the substation battery, SOC, and the current power injected by the grid to the distribution network in real-time. When an AGC signal is received from the system operator, a subroutine of mismatch calculation is performed at every iteration. If the calculated mismatch respective to the AGC signal is not within some predetermined tolerance then an optimization process may be executed to determine the optimal set-points of each regulating unit. In some implementations, the regulating active power set-points obtained from the Linearized Optimal Power Flow (LOPF) are dispatched and corrective action is taken to adjust the active power outputs of participating units (the participating DERs and the BESS) until the mismatch is within the tolerance. The power injected by the electric grid before and after the optimal dispatch collected from the real-time simulated network is next compared to observe if the requested amount of power from the System Operator is satisfied. When a new AGC command is received, a similar process of mismatch calculation, optimization, and corrective action is repeated.

Thus, referring again to FIG. 5, in step 502 the local machine or centralized controller initializes a time interval for receiving data from the electric grid, such as every 4 seconds (however, in some implementations the time interval may be either more or less than 4 seconds). Next, the centralized controller requests 504 the current status of the power distribution network, which includes requesting and obtaining the current DER setpoints, substation battery SOC and current setpoint, and the power supplied by the electric grid at the substation. The centralized controller then receives an AGC signal (or System Operator Request (SOR) signal) from a system operator 506 and calculates 508 a mismatch value. The mismatch value is calculated by first subtracting a P_{grid}_Current value from a P_{grid}_Previous value and then subtracting that result from the AGC (or SOR) value. The P_{grid}_Previous value is the power injected by the grid when the SO receives the particular AGC signal and the P_{grid}_Current value is the power injected by the grid after the optimal dispatch. Their difference helps to calculate the mismatch to determine if further correction is required. Thus, if the absolute value of the mismatch value is less than a predetermined value ε (“NO”) then the process ends 512 (in another embodiment, the process may be fed back to step 504).

However, if the absolute value of the mismatch value in step 520 is greater than the predetermined value ε (“YES”) then the centralized controller optimizes 514 the setpoints of the DERs and the BESS by using the inputs of the current DER setpoints, the mismatch value, a total DG power value, a total power loss value and a total demand value, then using an optimizer to linearize the optimal power flow resulting in optimal setpoints for the DERs and BESS. The optimal setpoints for the DERs and BESS are then dispatched 516 to each of the DERs being utilized and to the BESS and the process then is fed back to, and continues at, step 504.

In embodiments disclosed herein, a computationally efficient and fast optimization solution includes distribution system power flow as a subroutine in every iteration. The timeline for SFR is within the range from seconds to several minutes, and thus to achieve real-time control of regulation units in response to the AGC signal the controller must be able to determine the control decision and set-points quickly within the SFR timeframe. Therefore, a linearized model is utilized that does not neglect the non-linear loss term (which is comparatively very small to the line flows) because the consequences of an inaccurate decision by the secondary frequency controller due to the disregard of a loss term cannot be tolerated as it could cause global frequency problems. Therefore, the loss term is used in the power flow model.

Before discussing the quadratic loss terms present in the AC Dist-Flow models and how they are linearized, presented below is a chart of the nomenclature utilized:

| | |
|---|---|
| Pⱼ, Qⱼ | Real and reactive flow of branch from node j |
| Vⱼ, V₀ | Voltage of node j and substation voltage |
| pⱼ^{loss}, Qⱼ^{loss} | Real and reactive loss on branch from node j |
| Pⱼ^{L}, Qⱼ^{L} | Real and reactive load connected to node j |
| Rⱼ, Xⱼ | Resistance and Reactance of branch from node j |
| a, b, c, d | Slopes of each linear piece |
| j, k | Number of linear pieces for active and reactive |
| | power flows of a branch |
| N, N_{DG} | Number of nodes and Number of DERs |
| ΔP_{sys}, ΔP_{subs} | Change in power requested by the SO and the |
| | change in substation power |
| P_{DG, j}, Q_{DG, j} | Real and reactive power set-points of j^{th} DER |
| p_{DG}^{min}, p_{DG}^{max} | Real power limits of DERs |
| Ø_{d}, Ø_{b} | Power Factor Angle of DERs and Power |
| | Factor Angle of sBESS |
| Vₙ | Nominal Load Voltage |
| Pⱼ⁰,Qⱼ⁰ | Nominal Load Consumption |
| α₁, α₂, α₃ | Coefficient of Real Component of ZIP load |
| β₁, β₂, β₃ | Coefficient of Reactive Component of ZIP load |
| p_{BESS}^{max} | Maximum Real power limit of BESS |

As mentioned above, a linearized model of Dist-Flow has been adopted which does not neglect the non-linear loss term because the consequences of an inaccurate decision by the secondary frequency controller due to the disregard of a loss term cannot be tolerated as it could cause global frequency problems. Therefore, the loss term is linearized in the power flow model.

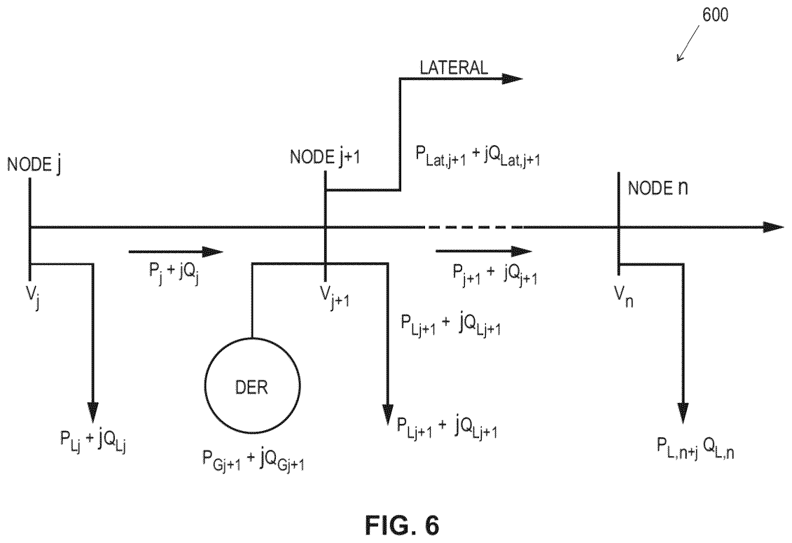

In particular, quadratic loss terms present in the AC Dist-Flow models are linearized using a Piece-wise linearization technique. FIG. 6 illustrates a portion of an active radial distribution network 600 for the illustration of the Dist-Flow power flow model. The active and reactive power balance equation for node (j+1) shown in FIG. 6 is given by equations (1) and (2) below, respectively.

$${P}_{j + 1} = {P}_{j} - {P}_{j}^{l o s s} - {P}_{j + 1}^{L} - {P}_{j + 1}^{L a t} + {P}_{j + 1}^{G} , ∀ j \qquad ( 1 )$$

$${Q}_{j + 1} = {Q}_{j} - {Q}_{j}^{l o s s} - {Q}_{j + 1}^{L} - {Q}_{j + 1}^{L a t} + {Q}_{j + 1}^{G} , ∀ j \qquad ( 2 )$$

$$Where : {P}_{j}^{l o s s} = {R}_{j} {I}_{j}^{2} = {R}_{j} \frac{{P}_{j}^{2} + {Q}_{j}^{2}}{{V}_{j}^{2}} \qquad ( 3 )$$

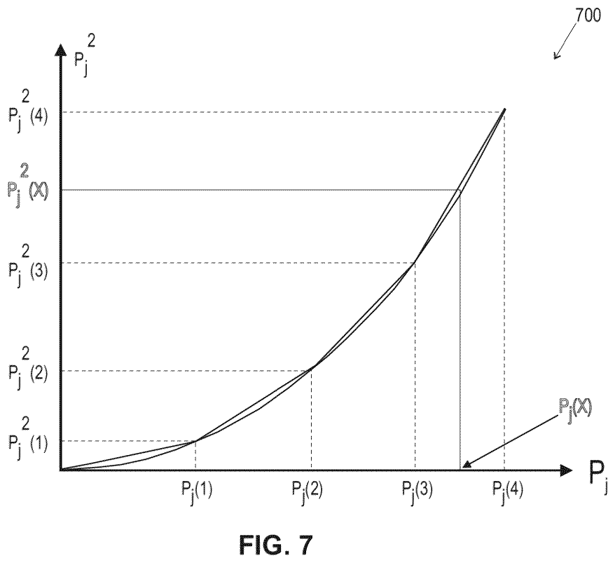

FIG. 7 is a graph 700 illustrating the application of piecewise linearization of quadratic active components of Pⱼ^{loss} given by equation (3). The linearization of the reactive component of pⱼ^{loss} can be realized similarly to the linearization shown in FIG. 6. The number of pieces for linearization should be determined carefully such that the linear approximation of the quadratic pieces does not result in large errors. A large number of linear pieces increases the computational burden for optimization whereas too small number may result in large errors. In some implementations, four linear pieces are used for both active and reactive loss approximation. The independent variable i.e., Pⱼ(x) is segmented into four pieces, and the dependent variable i.e., P² is approximated using linear pieces. Equation (4) below illustrates the four linearized components of Pⱼ²:

$${P}_{j}^{2} ( x ) = {\sum }_{n = 1}^{n - 1} s ( n ) ( {P}_{j} ( n ) - {P}_{j} ( n - 1 ) ) + s ( n ) ( {P}_{j} ( x ) - {P}_{j} ( n - 1 ) ) \qquad ( 4 )$$

Based on the piecewise linearization, equations (1)-(17) are fully linearized such that they are appropriate for SFR.

$${V}_{j + 1} = {V}_{j} - \frac{{R}_{j} {P}_{j} + {X}_{j} {Q}_{j}}{{V}_{0}} , ∀ j \qquad ( 5 )$$

$${P}_{j}^{l o s s} = {\sum }_{i ∈ Ij} {a}_{j , i} ( {P}_{j , i} - {P}_{j , i}^{*} ) + {\sum }_{k ∈ K j} {b}_{j , k} ( {Q}_{j , k} - {Q}_{j , k}^{*} ) \qquad ( 6 )$$

$${Q}_{j}^{l o s s} = {\sum }_{i ∈ Ij} {c}_{j , i} ( {P}_{j , i} - {P}_{j ,}^{*} ) + {\sum }_{k ∈ K j} {d}_{j , k} ( {Q}_{j , k} - {Q}_{j , k}^{*} ) \qquad ( 7 )$$

$${P}_{j} = {\sum }_{i ∈ Ij} ( {P}_{j , i} + {P}_{j , i}^{*} ) , {Q}_{j} = {\sum }_{k ∈ K j} ( {Q}_{j , k} + {Q}_{j , k}^{*} ) , ∀ j \qquad ( 8 )$$

$$0 \leq {P}_{j , i} \leq {P}_{j}^{i} - {P}_{j}^{i - 1} , ∀ i , j \qquad ( 9 )$$

$${P}_{j}^{i - 1} - {P}_{j}^{i} \leq {P}_{j , i}^{*} \leq 0 , ∀ i , j \qquad ( 10 )$$

$$0 \leq {Q}_{j , k} \leq {Q}_{j}^{k} - {Q}_{j}^{k - 1} , ∀ j , k \qquad ( 11 )$$

$${Q}_{j}^{k - 1} - {Q}_{j}^{i} \leq {Q}_{j , k}^{*} \leq 0 , ∀ j , k \qquad ( 12 )$$

$${f}_{j} ( x ) = \frac{{R}_{j}}{{V}_{0}^{2}} {x}^{2} , {g}_{j} ( x ) = \frac{{X}_{j}}{{V}_{0}^{2}} {x}^{2} , ∀ j \qquad ( 13 )$$

$${a}_{j i} = \frac{{f}_{j} ( {P}_{j}^{i} ) - {f}_{j} ( {P}_{j}^{i - 1} )}{{P}_{j}^{i} - {P}_{j}^{i - 1}} , ∀ i , j \qquad ( 14 )$$

$${b}_{j k} = \frac{{f}_{j} ( {Q}_{j}^{k} ) - {f}_{j} ( {Q}_{j}^{k - 1} )}{{Q}_{j}^{k} - {Q}_{j}^{k - 1}} , ∀ j , k \qquad ( 15 )$$

$${c}_{j i} = \frac{{g}_{j} ( {P}_{j}^{i} ) - {g}_{j} ( {P}_{j}^{i - 1} )}{{P}_{j}^{i} - {P}_{j}^{i - 1}} , ∀ i , j \qquad ( 16 )$$

$${d}_{j k} = \frac{{g}_{j} ( {Q}_{j}^{k} ) - {g}_{j} ( {Q}_{j}^{k - 1} )}{{Q}_{j}^{k} - {Q}_{j}^{k - 1}} , ∀ j , k \qquad ( 17 )$$

Equation (5) shows the voltage relationship between two adjacent nodes. Equations (6) and (7) illustrate the linearization of active and reactive losses. Equation (8) illustrates the segmentation of active and reactive flows. Equations (9)-(12) define the lower and upper limit of piecewise power flow variables. The power flow variable associated with the sign * takes reverse power flow into account. Equations (13)-(17) are used for calculating slopes for linear pieces.

Concerning the constraints for SFR, for the sake of simplicity these constraints are categorized as SOR constraints, DER constraints, BESS constraints, and ZIP load constraints (wherein the acronym ZIP stands for impedance (Z), current (I), and power (P)).
a) ZIP Load Constraints: Adopted is a ZIP load model that takes voltage-dependent characteristics of the load as a function of node voltage and nominal load. A polynomial equation that integrates constant impedance (Z), constant current (I), and constant power (P) characteristics of the active and reactive load is given below by equations (18) and (19):

$${P}_{j}^{L} = {P}_{j}^{0} [ ( 2 {α}_{1} + {α}_{2} ) ( \frac{{V}_{j}}{{V}_{n}} ) + ( {α}_{3} - {α}_{1} ) ] , ∀ j \qquad ( 18 )$$

$${Q}_{j}^{L} = {Q}_{j}^{0} [ ( 2 {β}_{1} + {β}_{2} ) ( \frac{{V}_{j}}{{V}_{n}} ) + ( {β}_{3} - {β}_{1} ) ] , ∀ j \qquad ( 19 )$$

where α₁+α₂+α₃=1 and where β₁+β₂+β₃=1.

The squared node voltage vⱼ present in equations (18) and (19) illustrates the non-linearity between the load and the node voltage. The quadratic voltage term is approximated by Vⱼ²=(2Vⱼ−1) which is reasonable as the node voltage is close to 1 p.u. The linearized versions of equations (18) and (19) are as follows:

$${P}_{j}^{L} = {P}_{j}^{0} [ ( 2 {α}_{1} + {α}_{2} ) ( \frac{{V}_{j}}{{V}_{n}} ) + ( {α}_{3} - {α}_{1} ) ] , ∀ j \qquad ( 20 )$$

$${Q}_{j}^{L} = {Q}_{j}^{0} [ ( 2 {β}_{1} + {β}_{2} ) ( \frac{{V}_{j}}{{V}_{n}} ) + ( {β}_{3} - {β}_{1} ) ] , ∀ j \qquad ( 21 )$$

b) DER Constraints: The dispatchable DERs are assumed to have both active and reactive power control. Constraints (22) and (23) below limit the active and reactive power outputs of DERs taking a fixed power factor into consideration.

$$0 \leq {P}_{D G , j} \leq {P}_{DG , j}^{max} , ∀ j ∈ 1 , … , {N}_{D G} \qquad ( 22 )$$

$$- tan ( {ϕ}_{d} ) \times {P}_{D G , j} \leq {Q}_{D G , j} \leq tan ( {ϕ}_{d} ) \times {P}_{D G , j} , ∖ ∀ j ∈ 1 , … , {N}_{D G} \qquad ( 23 )$$

c) Substation BESS Constraints: BESSs are considered suitable for frequency support as these resources have high ramping support. The optimal operation of substation BESS during optimization is based on the status of its SOC which is presented as follows:

$$B E S {S}_{operation} = \{ \begin{matrix}Charge / Discharge , & 0.1 \leq SO C \leq 0.9 \\ Trip , & Otherwise\end{matrix} \qquad ( 24 )$$

As SFR involves real-time control, the current SOC is utilized for the optimal dispatch of BESS rather than optimizing with the constraint of the next time-step SOC. The range of BESS operation lies within [−Pₘₐₓ, Pₘₐₓ], which provides both charging and discharging flexibility to the SO to regulate the frequency. The constraints associated with the BESS are shown in equations (25)-(27) where, the negative sign in equation (26) represents discharging operation.

$$0 \leq {P}_{B E S S}^{c} \leq {P}_{B E S S}^{max} \qquad ( 25 )$$

$$- {P}_{B E S S}^{max} \leq {P}_{B E S S}^{d} \leq 0 \qquad ( 26 )$$

$$- tan ( {ϕ}_{b} ) \times {P}_{BESS} \leq {Q}_{BESS} \leq tan ( {ϕ}_{b} ) \times {P}_{BESS} \qquad ( 27 )$$

Optimization Problem Formulation: Secondary frequency regulation (SFR) maintains a minute-to-minute energy balance throughout the day that involves frequent adjustment of the generating resources to oppose the Area Control Error (ACE). Specifically, AGC is performed by increasing or decreasing the resources' active power outputs in response to the AGC signal received from the System Operator (SO). Therefore, in addition to the consideration of SOR for SFR, optimal set-points are determined in such a way that the distribution network loss is simultaneously minimized. An optimization model that minimizes loss and dispatch regulating assets optimally for SFR is:

$$min {\sum }_{j = 1}^{N - 1} {R}_{j} \frac{{P}_{j}^{2} + {Q}_{j}^{2}}{{V}_{0}^{2}} \qquad ( 28 )$$

The above equation represents the objective of minimizing the loss of the distribution network, subject to constraints associated with the SOR in response to AGC. The constraints associated with the SOR in response to the AGC should be balanced by the overall changes of active set-points of DERs, BESS, system loss, and total load, and can be represented as follows:

$$Δ {P}_{s y s} = {\sum }_{j = 1}^{{N}_{DG}} Δ {P}_{DG , j} + Δ {P}_{BESS} + Δ {P}^{loss} + Δ {P}^{L} \qquad ( 29 )$$

Lastly, the equation shown below is utilized during optimization to enforce the node voltages to be within the permissible limit of 0.95 and 1.05:

$${V}_{min} \leq {V}_{j} \leq {V}_{max} , ∀ j ∈ 1 , … , N \qquad ( 30 )$$

Accordingly, disclosed herein are apparatus and methods that solve the technological problem of how to provide an optimized solution for secondary frequency regulation of a power grid in real-time by using a substation battery and DERs in a manner which simultaneously minimizes distribution loss and satisfies an AGC request by optimally dispatching power from or transmitting power to sBESS and DERs. In particular, a centralized controller advantageously tracks the AGC signal and reacts accordingly by utilizing sBESS and DERs to properly coordinate and dispatch corrective actions within the timeframe of secondary frequency regulation. Thus, small-scale assets (DERs) have applicability for grid services.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more such memories or storage devices.

As used herein, a “server” includes a computer device or system that responds to numerous requests for service from other devices.

As used herein, the term “module” refers broadly to software, hardware, middleware or firmware (or any combination thereof) components. Modules are typically functional components that can generate useful data or other output using specified input(s). A module may or may not be self-contained. An application program (sometimes called an “application” or an “app” or “App”) may include one or more modules, or a module can include one or more application programs.

The above descriptions and illustrations of processes herein should not be considered to imply a fixed order for performing the process steps. Rather, process steps may be performed in any order that is practicable, including simultaneous performance of at least some steps and/or omission of steps.

Although the present disclosure has been described in connection with specific example(s) and/or one or more embodiments, it should be understood that various changes, substitutions, and alterations will be apparent to those skilled in the art and can be made to the disclosed embodiments without departing from the spirit and scope of the disclosure.

What is claimed is:

1. A method for providing secondary frequency regulation support to a power transmission system, comprising:
requesting, by a real-time central controller from a power distribution network comprising a plurality of behind the meter (BTM) distributed energy resources (DERs) and at least one substation battery energy storage system (BESS), current status data of the power distribution network;
receiving, by the real-time central controller from the power distribution network, the current status data;
receiving, by the real-time central controller from a system operator, an Automatic Generation Control (AGC) signal;
calculating, by the real-time central controller, a mismatch value based on the current status data and the AGC signal;
determining, by the real-time central controller, that the absolute value of the mismatch value is greater than a predetermined tolerance; and
setting, by the real-time central controller in response to the determination, an optimal setpoint value for each of the plurality of DERs and an optimal setpoint value for the at least one BESS.

2. The method of claim 1, further comprising:
transmitting, by the real-time central controller via a distribution substation, a secondary frequency response comprising the optimal setpoint values to each of the plurality of DERs and the optimal setpoint value to the at least one BESS for secondary frequency regulation support.

3. The method of claim 2, wherein a time frame for the secondary frequency response comprises a range from several seconds to several minutes.

4. The method of claim 1, further comprising:
prior to requesting the current status data, initializing, by the real-time central controller, a time interval for requesting the receipt of current status data from the power distribution network.

5. The method of claim 1, wherein the plurality of DERs comprises fast-responding DERs.

6. The method of claim 1, wherein the current status data comprises a setpoint value for each of the plurality of distributed energy resources (DERs), a state-of-charge (SOC) value and a setpoint value of the substation battery energy storage system (BESS), and a power value representative of power supplied by the power transmission system.

7. The method of claim 6, wherein setting an optimal setpoint value for each of the plurality of DERs and an optimal setpoint value for the at least one BESS comprises:
receiving, by the central controller, input values comprising a current setpoint value for each of the plurality of DERs, the mismatch value, a total distributed generator (DG) value, a total power loss value, and a total demand value; and
generating, by the central controller using a linearized optimal power flow process, optimal setpoint values for each of the plurality of DERs and the optimal setpoint value for the at least one BESS.

8. The method of claim 1, wherein the real-time central controller receives the status data from the power distribution network at time intervals of four (4) seconds.

9. A central controller for providing secondary frequency regulation support to a power transmission system, comprising:
a processor; and
a memory operably connected to the processor, wherein the memory stores processor-executable instructions which when executed cause the processor to:
request current status data of a power distribution network, wherein the power distribution network comprises a plurality of behind the meter (BTM) distributed energy resources (DERs) and at least one substation battery energy storage system (BESS);
receive the current status data from the power distribution network;
receive an Automatic Generation Control (AGC) signal from a system operator;
calculate a mismatch value based on the current status data and the AGC signal;
determine that the absolute value of the mismatch value is greater than a predetermined tolerance; and
set, in response to the determination, an optimal setpoint value for each of the plurality of DERs and an optimal setpoint value for the at least one BESS.

10. The central controller of claim 9, wherein the memory further comprises processor-executable instructions which when executed cause the processor to transmit the optimal setpoint values to each of the plurality of DERs and the optimal setpoint value to the BESS for secondary frequency regulation support.

11. The central controller of claim 9, wherein a time frame for the secondary frequency response comprises a range from several seconds to several minutes.

12. The central controller of claim 9, wherein the memory further comprises processor-executable instructions which when executed cause the processor to:
prior to requesting the current status data, initialize a time interval for use in requesting the receipt of current status data from the power distribution network.

13. The central controller of claim 9 wherein the plurality of DERs comprise fast-responding DERs.

14. The central controller of claim 9, wherein the current status data comprises a setpoint value for each of the plurality of DERs, a state-of-charge (SOC) value and a setpoint value of the substation battery energy storage system (BESS), and a power value representative of power supplied by the power transmission system.

15. The central controller of claim 9, wherein the instructions for setting an optimal setpoint value for each of the plurality of DERs and an optimal setpoint value for the BESS comprises processor-executable instructions which when executed cause the processor to:
receive input values comprising a current setpoint value for each of the plurality of DERs, the mismatch value, a total distributed generator (DG) value, a total power loss value, and a total demand value; and
generate, using a linearized optimal power flow process, optimal setpoint values for each of the plurality of DERs and the optimal setpoint value for the BESS.

16. The central controller of claim 9, wherein the time interval for receiving status data from the power distribution network is four (4) seconds.

17. A high-level communication framework for simulating the dispatching of optimized set-points of distributed energy resources (DERs) for secondary frequency regulation of an electrical grid, comprising:
a gateway computer;
a local machine computer operably connected to the gateway computer; and
distribution grid assets operably connected to the gateway computer;
wherein the gateway computer includes a memory storing instructions which when executed cause the gateway computer to:
receive data from the distribution grid assets concerning a plurality of distributed energy resources (DERs) and concerning at least one battery energy storage system (BESS);
transmit the data from the distribution grid assets to the local machine computer;
receive data from the local machine computer comprising updated set-points for each of the plurality of DERs and for the at least one BESS; and
transmit the optimal set-points for each of the plurality of DERs to the distribution grid assets for dispatch to each respective DER.

18. The high-level communication framework of claim 17, wherein the local machine computer receives a state of charge (SOC) value and a power supplied value from the electrical grid at intervals of every four (4) seconds.
